(19) United States
(12) Patent Application Publication
(10) Pub. No.: US 2019/0363598 A1
(43) Pub. Date: Nov. 28, 2019

(54) APPARATUS FOR COOLING AN ELECTRIC MOTOR AND METHOD OF MAKING THE SAME

(71) Applicant: GM GLOBAL TECHNOLOGY OPERATIONS LLC, Detroit, MI (US)

(72) Inventors: Anthony M. COPPOLA, Rochester Hills, MI (US); Alireza FATEMI, Rochester Hills, MI (US); Derek F. LAHR, Howell, MI (US)

(73) Assignee: GM GLOBAL TECHNOLOGY OPERATIONS LLC, Detroit, MI (US)

(21) Appl. No.: 15/989,988

(22) Filed: May 25, 2018

(51) Int. Cl. H02K 3/24; H02K 1/16; H02K 3/12; H02K 3/28; H02K 3/30; H02K 3/34; H02K 15/12; H02K 15/02; H02K 15/085; H02K 15/10; B29C 45/14; B29C 45/00

(52) U.S. Cl. CPC H02K 3/24; H02K 1/16; H02K 3/12; H02K 3/28; H02K 3/30; H02K 3/345; B29L 2031/749; H02K 15/024; H02K 15/085; H02K 15/105; B29C 45/14; B29C 45/0053; H02K 15/12

(57) ABSTRACT

A stator for an electric motor is provided herein. The stator may include a stator body including a plurality of laminations, a plurality of wire windings, and winding end-turns formed by the wire windings. The stator may further include a polymeric composite housing disposed around at least a portion of an exterior surface of the stator body and a plurality of channels for heating and/or cooling the stator, which are defined in the polymeric composite housing. Methods of making the stator are also provided herein.

### INTRODUCTION

The present disclosure relates generally to an apparatus for cooling an electrical motor and a method of making the same, and more specifically, to a stator assembly including channels capable of receiving a fluid for cooling wire windings, laminations, or a combination thereof in the stator assembly.

Electric vehicles, including hybrid vehicles, employ electric motors, such as induction motors and permanent magnet motors, to propel the vehicles, as well as to capture braking energy when acting as an electric generator. The electric motor generally includes a rotor, which transmits torque through a gear set to the drive wheels of the vehicle, and a stator, which contains conductors in the form of wire windings. When in operation, the stator and the rotor generally require cooling. An electric motor typically can be actively cooled, for example, air cooled or liquid cooled, or passively cooled. An air cooled electric motor will typically have air blown over a stator core and wire windings. In this arrangement, the electric motor can be referred to as a non-sealed or open motor such that air is able to blow through the stator core and over the windings. In a closed or sealed motor, air is typically blown across cooling fins on an exterior case of the motor to dissipate waste heat from the motor. In either the non-sealed or the sealed motor, air-cooling provides less complex but relatively inefficient cooling of the electric motor as compared to liquid cooling.

A liquid-cooled electric motor can have an annular jacket positioned between an outside diameter of the stator core and an inside diameter of the exterior case. Water can be circulated through the jacket and around the stator core to remove heat that is produced in the stator core and in the stator windings. Traditionally, the jacket is located relatively far from winding end-turns and does not have contact with winding end-turns. It can be appreciated that heat generated in the winding end-turns travels through the windings and stator core to be extracted by the jacket. The thermal path from the winding end-turns through portions of the stator core to the liquid jacket typically includes many materials with low thermal conductivity, which can reduce cooling to the winding end-turns.

### SUMMARY

This section provides a general summary of the disclosure, and is not a comprehensive disclosure of its full scope or all of its features.

In certain aspects, the present disclosure provides a stator for an electric motor including a plurality of laminations each including a plurality of slots, wherein the plurality of slots collectively define a first end face and a second end face. The stator further includes a plurality of wire windings disposed in the plurality of slots, a first plurality of winding end-turns formed by the respective wire windings adjacent to the first end face, and a second plurality of winding end-turns formed by the respective wire windings adjacent to the second end face. The first plurality of winding end-turns has a first outer periphery and the second plurality of winding end-turns has a second outer periphery. A first polymeric composite housing can be disposed around at least a portion of the first outer periphery of the first plurality of winding end-turns, and a second polymeric composite housing can be disposed around at least a portion of the second outer periphery of the second plurality of winding end-turns, wherein the first polymeric composite housing and the second polymeric composite housing each includes a polymer. The stator further includes a plurality of channels for receiving a fluid for heating and/or cooling the first plurality of winding end-turnsand the second plurality of winding end-turns. The plurality of channels may be defined in one or more of: (i) the first polymeric composite housing; (ii) the second polymeric composite housing; (iii) regions between respective wire windings of the first plurality of winding end-turns; and (iv) regions between respective wire windings of the second plurality of winding end-turns.

The polymer in the first and the second polymeric composite housing each can include a thermoplastic polymer or thermoset polymer.

The first and the second polymeric composite housing can each further include a plurality of reinforcing fibers. The plurality of reinforcing fibers can be continuous fibers selected from the group consisting of carbon fibers, glass fibers, aramid fibers, polyethylene fibers, organic fibers, metallic fibers, ceramic fibers, basalt fibers, quartz fibers, graphite fibers, nanofibers, boron fibers, and a combination thereof.

The plurality of channels can include an outer shell including a metal, a polymer, a polymeric composite, a ceramic, or a combination thereof.

The plurality of channels can be defined in the first polymeric composite housing and in the second polymeric composite housing. The channels in the first polymeric composite housing can extend circumferentially around the first plurality of winding end-turns, and the plurality of channels in the second polymeric composite housing can extend circumferentially around the second plurality of winding end-turns.

The plurality of channels in the first polymeric composite housing can be interconnected with one another and the plurality of channels in the second polymeric composite housing can be interconnected with one another.

The plurality of channels in the first polymeric composite housing respectively include a first inlet and a first outlet, and the plurality of channels in the second polymeric composite housing respectively include a second inlet and a second outlet.

The plurality of channels in the first polymeric composite housing can be in fluid communication with the plurality of channels in the second polymeric composite housing.

The plurality of channels may be defined in the first polymeric composite housing and in the second polymeric composite housing. The plurality of channels in the first polymeric composite housing can extend radially between respective winding end-turns in the first plurality of winding end-turns and between the respective wire windings, and the plurality of channels in the second polymeric composite housing can extend radially between respective winding end-turns in the second plurality of winding end-turns and between the respective wire windings.

The plurality of channels in the first polymeric composite housing can be interconnected with one another by a first manifold channel, and the plurality of channels in the second polymeric composite housing can be interconnected with one another by a second manifold channel.

The plurality of channels can be formed by applying a channel precursor material including a sacrificial material to the stator to form an intermediate stator assembly, placing the intermediate stator assembly in a mold, introducing a polymer precursor into the mold, solidifying the polymer precursor to form the first polymeric composite housing and the second polymer composite housing, and removing the sacrificial material to form the plurality of channels.

In other aspects, the present disclosure provides a method of manufacturing a stator with a plurality of channels. The method includes applying a channel precursor material including a sacrificial material to the stator to form an intermediate stator assembly. The stator includes a plurality of laminations each including a plurality of slots, wherein the plurality of slots collectively define a first end face and a second end face. The stator further includes a plurality of wire windings disposed in the plurality of slots, a first plurality of winding end-turns formed by the respective wire windings adjacent to the first end face, and a second plurality of winding end-turns formed by the respective wire windings adjacent to the second end face. The first plurality of winding end-turns has a first outer periphery and the second plurality of winding end-turns has a second outer periphery. The method may further include placing the intermediate stator assembly in a mold, introducing a polymer precursor into the mold, and solidifying the polymer precursor to form a solid polymeric stator assembly including a first polymeric composite housing disposed around at least a portion of the first outer periphery of the first plurality of winding end-turns and a second polymeric composite housing disposed around at least a portion of the second outer periphery of the second plurality of winding end-turns. The first polymeric composite housing and the second polymeric composite housing each include a polymer. The method further includes removing the sacrificial material to form the plurality of channels defined in one or more of: (i) the first polymeric composite housing; (ii) the second polymeric composite housing; (iii) regions between respective wire windings of the first plurality of winding end-turns; and (iv) regions between respective wire windings of the second plurality of winding end-turns.

The polymer precursor can include a thermoplastic polymer or a thermoset polymer.

Applying the channel precursor material can include applying the channel precursor material circumferentially around the first plurality of winding end-turns, and applying the channel precursor material circumferentially around the second plurality of winding end-turns.

Applying the channel precursor material can include applying the channel precursor material to at least a portion of the regions between the respective wire windings of the first plurality of winding end-turns and the second plurality of winding end-turns.

Applying the channel precursor material can include applying the channel precursor material radially between respective winding end-turns in the first plurality of winding end-turns, and applying the channel precursor material radially between respective winding end-turns in the second plurality of winding end-turns.

The sacrificial material can include a material capable of one or more of melting, vaporizing, deflagrating, and solubilizing.

The channel precursor material can include an outer shell containing the sacrificial material. The outer shell may include a metal, a polymer, a polymeric composite, a ceramic, or a combination thereof, and the sacrificial material may include a gas or a material capable of one or more of melting, vaporizing, deflagrating, and solubilizing. The shell can remain after the sacrificial material is removed.

The method can further include removing the solid polymeric stator assembly from the mold and placing the solid polymeric stator assembly in a stator housing before removing the sacrificial material or further include placing the intermediate assembly in the stator housing and placing the intermediate assembly in the stator housing in the mold.

In other aspects, the present disclosure provides a stator for an electric motor including a plurality of laminations each including a plurality of slots, wherein the plurality of slots collectively define a first end face and a second end face, and wherein the plurality of laminations has as an exterior surface. The stator further includes a plurality of wire windings disposed in the slots plurality of, a first plurality of winding end-turns formed by the respective wire windings adjacent to the first end face, and a second plurality of winding end-turns formed by the respective wire windings adjacent to the second end face. The first plurality of winding end-turns has a first outer periphery and the second plurality of winding end-turns has a second outer periphery. The stator further includes a polymeric composite housing and a plurality of channels for receiving a fluid for heating and/or cooling the stator, wherein the plurality of channels are defined in the polymeric composite housing. The polymeric housing can be disposed around: (i) at least a portion of the exterior surface of the laminations; (ii) at least a portion of the first outer periphery of the first plurality of winding end-turns; and (iii) at least a portion of the second outer periphery of the second plurality of winding end-turns. The polymeric composite housing can include a polymer.

The polymer in the polymeric composite housing can include a thermoplastic polymer or a thermoset polymer.

The polymeric composite housing can each further include a plurality of reinforcing fibers. The plurality of reinforcing fibers can be continuous fibers selected from the group consisting of carbon fibers, glass fibers, aramid fibers, polyethylene fibers, organic fibers, metallic fibers, ceramic fibers, basalt fibers, quartz fibers, graphite fibers, nanofibers, boron fibers, and a combination thereof.

The plurality of channels can include an outer shell including a metal, a polymer, a polymeric composite, a ceramic, or a combination thereof.

The plurality of channels in the polymeric composite housing can extend circumferentially around: (i) the exterior surface of the laminations; (ii) the first plurality of winding end-turns; and (iii) the second plurality of winding end-turns.

The plurality of channels may be interconnected with one another.

The plurality of channels can include a third inlet and a third outlet.

The plurality of channels can be formed by applying a channel precursor material including a sacrificial material to the stator to form an intermediate stator assembly, placing the intermediate stator assembly in a mold, introducing a polymer precursor into the mold, solidifying the polymer precursor to form the polymeric composite housing, and removing the sacrificial material to form the plurality of channels.

In other aspects, the present disclosure provides a method of manufacturing a stator with a plurality of channels. The method includes applying a channel precursor material including a sacrificial material to the stator to form an intermediate stator assembly. The stator includes a plurality of laminations each including a plurality of slots, wherein the plurality of slots collectively a first end face and a second end face, and wherein the plurality of laminations has as an exterior surface. The stator further includes a plurality of wire windings disposed in the plurality of slots, a first plurality of winding end-turns formed by the respective wire windings adjacent to the first end face, and a second plurality of winding end-turns formed by the respective wire windings adjacent to the second end face. The first plurality of winding end-turns has a first outer periphery and the second plurality of winding end-turns has a second outer periphery. The method further includes placing the intermediate stator assembly in a mold, introducing a polymer precursor into the mold, solidifying the polymer precursor to form a solid polymeric stator assembly including a polymeric composite housing, and removing the sacrificial material to form the plurality of channels defined in the polymeric composite housing. The polymeric composite housing can be disposed around: (i) at least a portion of the exterior surface of the laminations; (ii) at least a portion of the first outer periphery of the first plurality of winding end-turns; and (iii) at least a portion of the second outer periphery of the second plurality of winding end-turns. The polymeric composite housing can include a polymer.

The polymer can include a thermoplastic polymer or a thermoset polymer.

The channel precursor material can further include a plurality of reinforcing fibers or the method can further include arranging the plurality of reinforcing fibers adjacent to at least a portion of the intermediate stator assembly. The plurality of reinforcing fibers can be continuous fibers selected from the group consisting of carbon fibers, glass fibers, aramid fibers, polyethylene fibers, organic fibers, metallic fibers, ceramic fibers, basalt fibers, quartz fibers, graphite fibers, nanofibers, boron fibers, and a combination thereof.

Applying the channel precursor material may include applying the channel precursor material circumferentially around: (i) the exterior surface of the laminations; (ii) the first plurality of winding end-turns; and (iii) the second plurality of winding end-turns.

The sacrificial material can include a material capable of one or more of melting, vaporizing, deflagrating, and solubilizing.

The channel precursor material can include an outer shell containing the sacrificial material. The outer shell may include a metal, a polymer, a polymeric composite, a ceramic, or a combination thereof, and the sacrificial material may include a gas or a material capable of one or more of melting, vaporizing, deflagrating, and solubilizing. The shell can remain after the sacrificial material is removed.

The method may further include applying an insert to the intermediate stator assembly.

In other aspects, the present disclosure provides a stator for an electric motor including a stator body including a plurality of laminations, a plurality of wire windings, and a plurality of winding end-turns formed by the respective wire windings. The stator further includes a polymeric composite housing disposed around at least a portion of an exterior surface of the stator body, and a plurality of channels for receiving a fluid for heating and/or cooling the stator, wherein the plurality of channels are defined in the polymeric composite housing. The polymeric composite housing includes a polymer.

The polymer in the polymeric composite housing can include a thermoplastic polymer or a thermoset polymer.

The polymeric composite housing can further include a plurality of reinforcing fibers. The plurality of reinforcing fibers may be continuous fibers selected from the group consisting of carbon fibers, glass fibers, aramid fibers, polyethylene fibers, organic fibers, metallic fibers, ceramic fibers, basalt fibers, quartz fibers, graphite fibers, nanofibers, boron fibers, and a combination thereof.

The channels can include an outer shell include a metal, a polymer, a polymeric composite, a ceramic, or a combination thereof.

The plurality of channels can be formed by applying a channel precursor material including a sacrificial material to the stator body to form an intermediate stator assembly, placing the intermediate stator assembly in a mold, introducing a polymer precursor into the mold, solidifying the polymer precursor to form the polymeric composite housing, and removing the sacrificial material to form the plurality of channels.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is perspective view of a stator assembly including a polymeric composite housing and channels defined therein according to one aspect of the disclosure.

FIG. 2 is a cross-sectional perspective view of the stator assembly of FIG. 1.

FIG. 3A is a cross-sectional view of a single lamination according to one aspect of the disclosure.

FIG. 3B is a perspective view of a plurality of laminations according to one aspect of the disclosure.

FIG. 4A is a perspective view of a stator assembly including a concentrated winding configuration according to another aspect of the disclosure.

FIG. 4B is a flattened cross-sectional view of the stator assembly of FIG. 4A on a plane perpendicular to the rotational axis of the assembly.

FIG. 4C is a flattened cross-sectional view of FIG. 4B along line B-B according to one aspect of the disclosure.

FIG. 4D is a flattened cross-sectional view of FIG. 4B along line B-B according to another aspect of the disclosure.

FIG. 5A is a perspective view of a portion of a stator assembly including bar wound end-turns according to another aspect of the disclosure.

FIG. 5B is a flattened cross-sectional view of the stator assembly of FIG. 5A along line C-C.

FIG. 5C is a flattened cross-sectional view of the stator assembly of FIG. 5A along line C-C including a polymeric composite housing and channels.

FIG. 6 is perspective view of a stator assembly including a polymeric composite housing and channels defined therein according to another aspect of the disclosure.

FIG. 7 is flattened side cross-sectional view of the stator assembly of FIG. 6

FIG. 8 is a cross-sectional view of a channel including an outer shell.

FIG. 9A-9D illustrate a method of making a stator assembly according to one aspect of the disclosure. FIG. 9A is a flattened top view of an intermediate stator assembly illustrating application of channel material to winding end-turns according to one aspect of the disclosure. FIG. 9B is a flattened cross-sectional view of the intermediate stator assembly of FIG. 9A. FIG. 9C is a flattened cross-section of the stator body of FIG. 9A illustrating formation of a solid polymeric stator assembly according to one aspect of the disclosure. FIG. 9D is a flattened cross-sectional view of the stator body of FIG. 9A illustrating formation of channels in the first and second polymeric composite housing.

FIG. 10A-10C illustrate a method of making a stator assembly according to another aspect of the disclosure. FIG. 10A is a flattened cross-sectional view of stator assembly 400 along line A-A from FIG. 4A illustrating application of sacrificial material to form an intermediate stator assembly according to another aspect of the disclosure. FIG. 10B is a flattened cross-sectional view of stator assembly 400 along line A-A from FIG. 4A illustrating formation of a solid polymeric stator assembly according to another aspect of the disclosure.

FIG. 10C is a flattened cross-sectional view of stator assembly 400 along line A-A from FIG. 4A illustrating formation of channels in the first polymeric composite housing.

FIG. 11A-11C illustrate a method of making a stator assembly according to another aspect of the disclosure. FIG. 11A is a flattened cross-sectional view of stator assembly 500 along line C-C from FIG. 5A illustrating application of sacrificial material to form an intermediate stator assembly according to another aspect of the disclosure. FIG. 11B is a flattened cross-sectional view of stator assembly 500 along line C-C from FIG. 5A illustrating formation of a solid polymeric stator assembly according to another aspect of the disclosure.

FIG. 11C is a flattened cross-sectional view of stator assembly 500 along line C-C from FIG. 5A illustrating formation of channels in the first polymeric composite housing.

FIG. 12A-12F illustrate a method of making a stator assembly according to another aspect of the disclosure. FIG. 12A is a side view of a stator assembly according to one aspect of the disclosure illustrating application of sacrificial material to form an intermediate stator assembly according to another aspect of the disclosure. FIG. 12B is a side view of an alternative intermediate stator assembly according to another aspect of the disclosure. FIG. 12C is a side view of an alternative intermediate stator assembly according to another aspect of the disclosure. FIG. 12D is a side view of a solid polymeric stator assembly according to another aspect of the disclosure. FIG. 12E is a side view of an alternative solid polymeric stator assembly according to another aspect of the disclosure. FIG. 12F is a side view illustrating formation of channels in a polymeric composite housing.

FIG. 13A is a cross-sectional view of a sacrificial material according to one aspect of the disclosure.

FIG. 13B is a cross-sectional view of a sacrificial material according to another aspect of the disclosure.

FIG. 14 is an alternative arrangement of the intermediate stator assembly from FIG. 9B.

FIG. 15 is an alternative arrangement of the solid polymeric stator assembly from FIG. 9C.

FIG. 16 is an electric motor assembly according to one aspect of the disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” “attached to,” or “coupled to” another element or layer, it may be directly on, engaged, connected, attached or coupled to the other component, element, or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

It should be understood for any recitation of a method, composition, device, or system that “comprises” certain steps, ingredients, or features, that in certain alternative variations, it is also contemplated that such a method, composition, device, or system may also “consist essentially of” the enumerated steps, ingredients, or features, so that any other steps, ingredients, or features that would materially alter the basic and novel characteristics of the invention are excluded therefrom.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

### I. Stator Assemblies

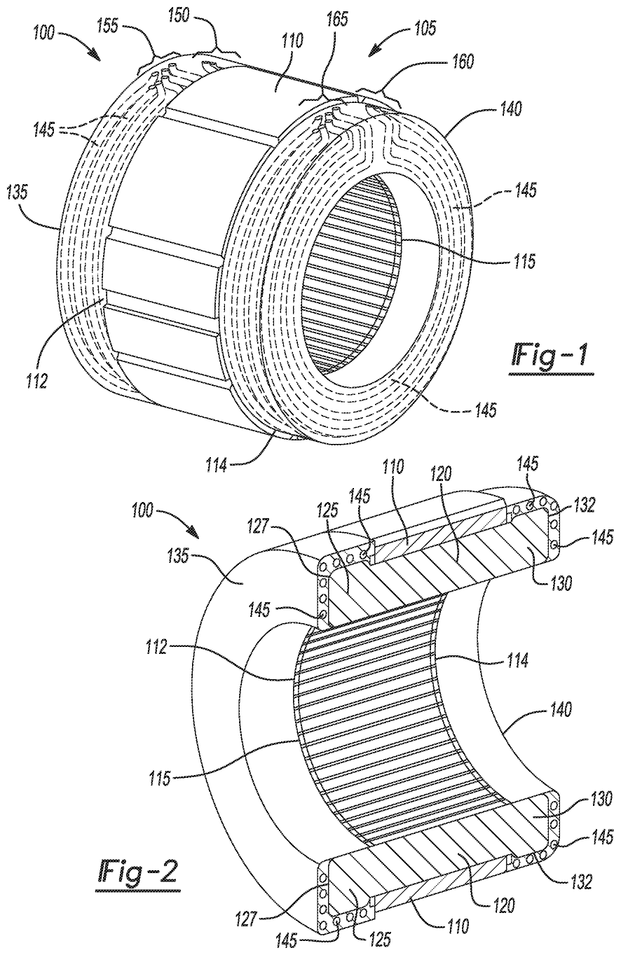

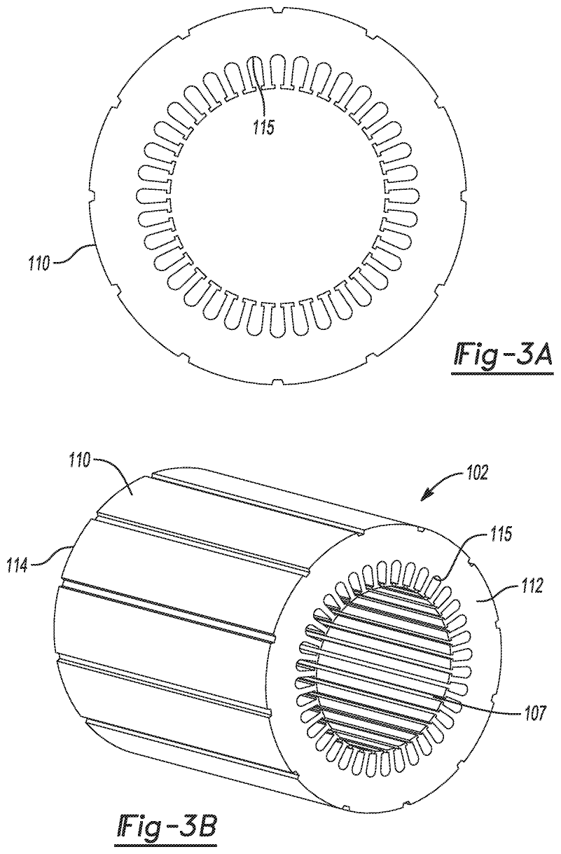

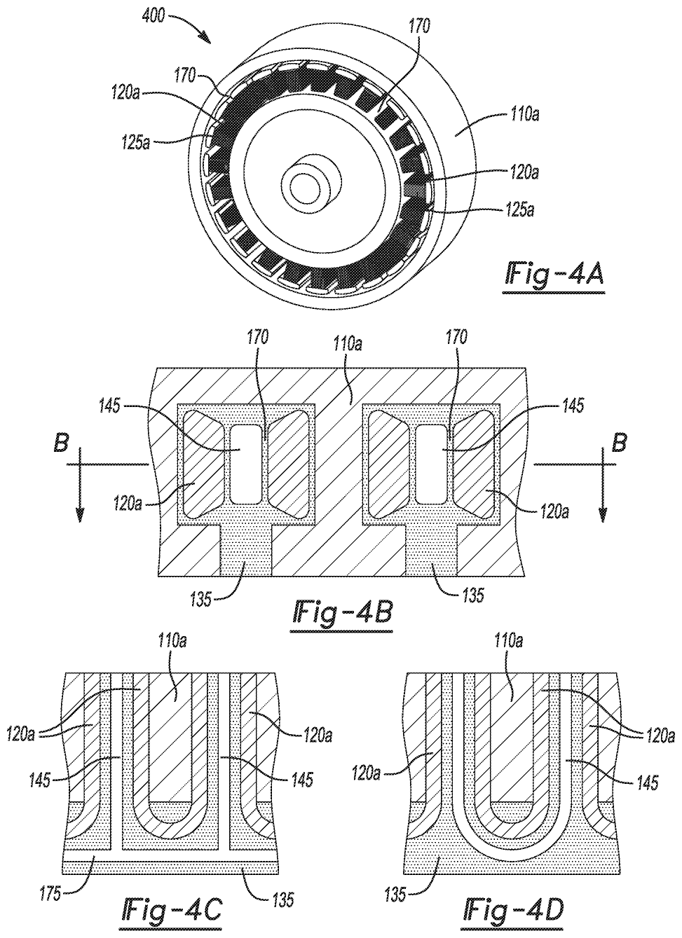

With reference to FIGS. 1 and 2, portions of an exemplary stator 100, also referred to as stator assembly 100, are shown. The stator 100 includes a stator body 105 including a plurality of laminations 110 (also referred to herein as “laminations 110”) and a plurality of slots 115 (also referred to herein as “slots 115”) formed within each of the laminations 110. The plurality of slots 115 can be formed in each of the laminations 110 in any suitable configurations as known in the art. In some embodiments, the stator 100 including laminations 110 and slots 115 defined therein may be configured for flux flow in a radial direction (see FIGS. 1 and 2). In alternative embodiments, the stator 100 including laminations 110 and slots 115 defined therein may be configured for flux flow in an axial direction. For example, FIG. 3A depicts a single lamination 110 with a plurality of slots 115 in one suitable configuration, and FIG. 3B shows an assembly 102 of the plurality of laminations 110 without any further components for clarity purposes wherein the plurality of laminations 110 are arranged for flux flow in a radial direction. As shown in FIG. 3B, the plurality of slots 115 collectively define a first end face 112 and a second end face 114. The plurality of slots 115 further define stator channels 107 between the first end face 112 and the second end face 114. The laminations 110 can comprise any suitable magnetic metallic material and alloys thereof, such as, but not limited to, steel, silicon-containing alloys, iron-containing alloys, nickel-containing alloys, cobalt-containing alloys and combinations thereof.

Referring back to FIGS. 1 and 2, the stator body 105 can further include a plurality of electrically conductive wire windings 120 (e.g., copper magnet wiring) wound in and through the slots 115. The wire windings 120 can also be referred to as coil windings 120. The wire windings 120 can be placed in the slots 115 and travel back and forth longitudinally between the first end face 112 and the second end face 114. Although not shown, it is contemplated herein that the wire windings 120 can be placed in the slots 115 and travel back and forth axially between the first end face 112 and the second end face 114. Winding end-turns can be formed as the wire-windings 120 exit either end of the laminations 110. For example, a first plurality of winding end-turns 125 can be formed as the respective wire windings 120 exit at the first end face 112 and are redirected into subsequent slots 115 and/or are redirected in and through the same slot 115. The first plurality of winding end-turns 125 can have a first outer periphery 127. A second plurality of winding end-turns 130 can be formed as the respective wire windings 120 exit at the second end face 114 and are redirected into subsequent slots 115 and/or are redirected in and through the same slot 115. The second plurality of winding end-turns 130 can have a second outer periphery 132. In various aspects, the first winding end-turns 125 and/or the second winding end-turns 130 can be formed in an annular ring around the first end-face 112 and the second end-face 114, respectively, and abut the laminations 110. While FIGS. 1 and 2 depict distributed windings with stranded windings, other types of winding configurations and winding technologies as understood in the art are also contemplated herein and may be included in the stator body, for example, concentrated winding configurations, and bar wound winding technology. The plurality of laminations 110, wire windings 120, first plurality of winding end-turns 125, and the second plurality of winding end-turns 130 are illustrated in FIGS. 1 and 2 (and in later figures) as a solid portion. However, it is appreciated that the plurality of laminations 110 can be a plurality of separate laminations, and the wire windings 120, first plurality of winding end-turns 125, and the second plurality of winding end-turns 130 can be a plurality of separate electrically-conductive wires. Additionally, as used herein, the term “plurality of laminations” encompasses from one lamination to any number of suitable laminations as understood in the art (e.g, 5 laminations, 10 laminations, 100 laminations, 1000 laminations, etc.).

As an electric motor operates, the stator generates heat and generally requires cooling because elevated temperatures can reduce motor durability and decrease efficiency. It has been discovered that including a polymeric composite housing (as further described below) disposed around at least an exterior portion of the stator body 105 and a plurality of channels directly or indirectly adjacent to the exterior of the stator body 105 can advantageously achieve efficient cooling of the stator body 105 by flowing a heat transfer fluid through the plurality of channels (as further described below) at a suitable cooling temperature. It is also contemplated herein that the heat transfer fluid flowing through the plurality of channels can be used for heating a stator as well. The plurality of channels may be defined in the polymeric composite housing, in at least a portion of regions between wires in winding end-turns, or a combination thereof. In particular, it can be especially difficult to cool the winding end-turns (e.g., winding-end turns 125, winding-end turns 130). For example, typical cooling jackets only contact the laminations such that the cooling of the winding end-turns is greatly reduced. However, it has been discovered that winding end-turns can be cooled with increased efficiency by including a polymeric composite housing disposed around an outer periphery of the winding end-turns, wherein a plurality of channels for receiving a heat transfer fluid can be defined in the polymeric composite housing.

Thus, in various aspects, as shown in FIGS. 1 and 2, the stator 100 can further include a first polymeric composite house 135 disposed around at least a portion of the first outer periphery 127 of the first plurality of winding end-turns 125. The stator 100 can further include a second polymeric composite housing 140 disposed around at least a portion of the second outer periphery 132 of the second plurality of winding end-turns 130. Although FIGS. 1 and 2 shows both a first polymeric composite housing 135 and a second polymeric housing 140, it is contemplated herein that the stator 100 may include only one of the first polymeric composite housing 135 and the second polymeric housing 140.

Additionally, the stator 100 includes a plurality of channels 145 (also referred to herein as “channels 145”) for receiving a fluid, such as a heat transfer fluid, for heating and/or cooling the first plurality of winding end-turns 125 and/or the second plurality of winding end-turns 130. Examples of suitable heat transfer fluids include, but are not limited to, air, water, oil, ethylene glycol, propylene glycol, glycerol, methanol, and combinations thereof. The air may be supplied from an air conditioning system or produced from movement of the vehicle. The heat transfer fluid may be at supplied at a suitable temperature to cool and/or heat the stator assembly 100, e.g., about −40° C. to about 120° C., about −40° C. to about 20° C., about 10° C. to about 120° C., about 20° C. to about 100° C. or about 20° C. to about 90° C.

As illustrated in FIGS. 1 and 2, the plurality of channels 145 may be defined in the first polymeric composite housing 135 and the second polymeric composite housing 140. Although FIGS. 1 and 2 depict channels 145 defined in both the first polymeric composite housing 135 and the second polymeric housing 140, it is contemplated herein that the stator 100 may include channels 145 defined in either the first polymeric composite housing 135 or the second polymeric housing 140.

In various aspects, the channels 145 may be oriented in any suitable configuration in a polymeric composite housing (e.g., first polymeric composite housing 135, second polymeric composite housing 140) for example, circumferentially, radially, branched, intersecting, criss-crossing and combinations thereof. For example, as shown in FIG. 1, the channels 145 may extend circumferentially around the first plurality of winding end-turns 125. Additionally, the channels 145 may extend circumferentially around the second plurality of winding end-turns 130. Although FIGS. 1 and 2 depict channels 145 extending circumferentially around both the first polymeric composite housing 135 and the second polymeric housing 140, it is contemplated herein that the channels 145 may have different configurations in the first polymeric composite housing 135 and in the second polymeric housing 140, for example, circumferentially and radially. As used herein, “circumferentially around” is intended to encompass configurations where the channels 145 extend circumferentially around the winding end-turns (e.g., first plurality of winding end-turns 125, second plurality of winding end-turns 132) along an outer periphery (e.g., first outer periphery 127, second outer periphery 132) of the winding end-turns and/or within an interior region of the winding end-turns, for example, wherein the channels 145 are interwoven within the wires of the winding end-turns. Although not shown, it is contemplated herein that a polymeric composite housing (e.g., first polymeric composite housing 135, second polymeric composite housing 140) may extend around or encapsulate other portions of the wire windings (e.g., wire windings 120) present in slots (e.g., slots 115) of the laminations (e g, laminations 110) and channels (e.g., channels 145) may be defined in such a polymeric composite housing.

In some embodiments, the channels 145 in the first polymeric composite housing 135 may be interconnected with one another including fluidly interconnected and/or physically interconnected. Additionally or alternatively, the channels 145 in the second polymeric composite housing 140 may be interconnected with one another including fluidly connected and/or physically interconnected. As depicted in FIG. 1, channels 145 in the first polymeric composite housing 135 may respectively comprise a first inlet 150 for receiving a heat transfer fluid and a first outlet 155 for removal of the spent heat transfer fluid. The first inlet 150 may comprise one or more channels 145, and the first outlet 155 may comprise one or more channels 145. Additionally or alternatively, the channels 145 in the second polymeric composite housing 140 may respectively comprise a second inlet 160 for receiving a heat transfer fluid and a second outlet 165 for removal of the spent heat transfer fluid. The second inlet 160 may comprise one or more channels 145, and the second outlet 165 may comprise one or more channels 145. It is contemplated herein that the first polymeric housing 135 and the second polymeric housing 140 may include one or more inlets and/or one or more outlets accessing the channels 145. Although not shown, channels 145 in the first polymeric composite housing 135 may be in fluid communication, for example, fluidly interconnected and/or physically interconnected, with the channels 145 in the second polymeric composite housing 140. In such embodiments, the channels 145 may comprise one or more inlets (not shown) and one or more outlets (not shown).

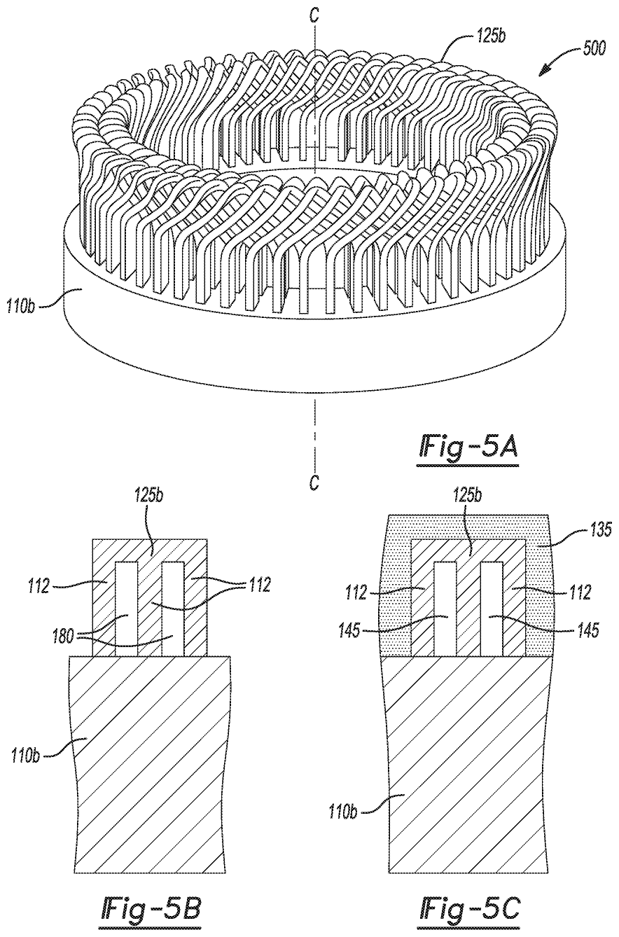

Additionally or alternatively, where the channels 145 are defined in a polymeric composite housing (e.g., first polymeric composite housing 135, second polymeric composite housing 140), the channels 145 may extend radially between end-turns of the winding end-turns (e.g. first plurality of winding end-turns 125, second plurality of winding-end turns 130) as well as between wire windings (e.g., wire windings 120). For example, as depicted in FIG. 4A for a stator assembly 400, which does not show a polymeric composite housing or channels for clarity purposes, a first plurality of winding end-turns 125a may be present as concentrated winding end-turns with gaps 170 between end-turns and wherein the gaps 170 extend radially between wire windings 120a. The channels 145 (not shown) may extend radially in at least a portion of the gaps 170 between the winding-end turns 125a and further between respective wire windings 120a. FIG. 4B, which shows a flattened cross-sectional slice of the stator assembly 400 on a plane perpendicular to the rotational axis of the assembly, depicts stator assembly 400 including a first polymeric composite housing 135, wire windings 120a, laminations 110a, and channels 145 defined in the first polymeric composite housing 135 in the gaps 170 radially extending between respective wire windings 120a. Although, not shown in FIG. 4B, the channels 145 defined in the first polymeric composite housing 135 may also radially extend in the gaps 170 between respective winding end-turns 125a As depicted in FIG. 4B, it is contemplated herein that the first polymeric composite housing 135 (or the second polymeric composite housing 140 (not shown) may be present in at least a portion of the gaps 170 between the wire windings 120a. In such embodiments, the channels 145 may be in fluid communication with each other, for example, interconnected with one another via a manifold channel. For example, as shown in FIG. 4C, a first manifold channel 175 connects channels 145 between wire windings 120a. Although not shown, a second manifold channel may connect channels 145 in a second polymeric housing. Additionally or alternatively, as depicted in FIG. 4D, the channels 145 between windings 120a may be physically interconnected with one another.

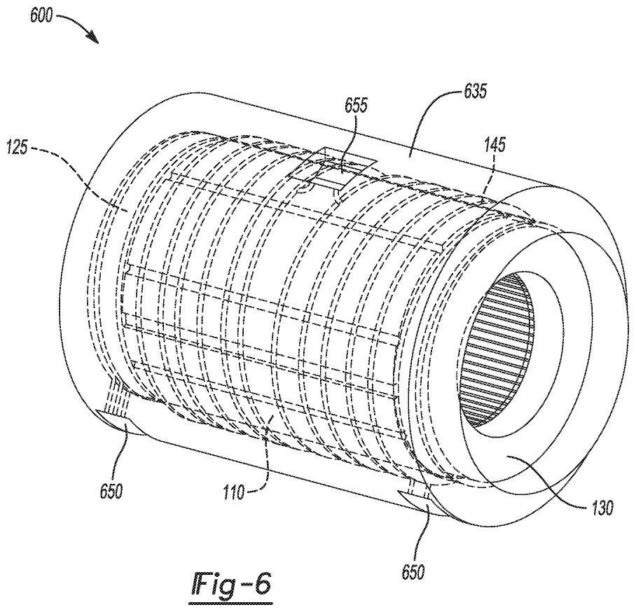

In alternative embodiments, the channels 145 may be defined in at least a portion of regions between respective wire windings (e.g., between individual wires) of the winding end-turns (e.g., first plurality of winding end-turns 125, second plurality of winding end-turns 130), for example, where the winding end-turns are in a bar wound configuration. FIG. 5A shows a stator assembly 500, which does not show a polymeric composite housing or channels for clarity purposes, where a first plurality of winding end-turns 125b are present in a bar wound configuration. As depicted in FIG. 5B, a flattened cross-sectional view of stator assembly 500 along line C-C, regions 180 are present between respective wire windings 112 (or wires 112) in the winding end-turns 125b. Inclusion of a first polymeric composite housing 135 and channels 145 in stator assembly 500 is illustrated in FIG. 5C, which depicts a first polymeric composite housing 135, winding end-turns 125b, laminations 110b, and channels 145 defined in regions 180 (not shown because replaced with channels 145) between respective wire windings 112 in the winding end-turns 125b.

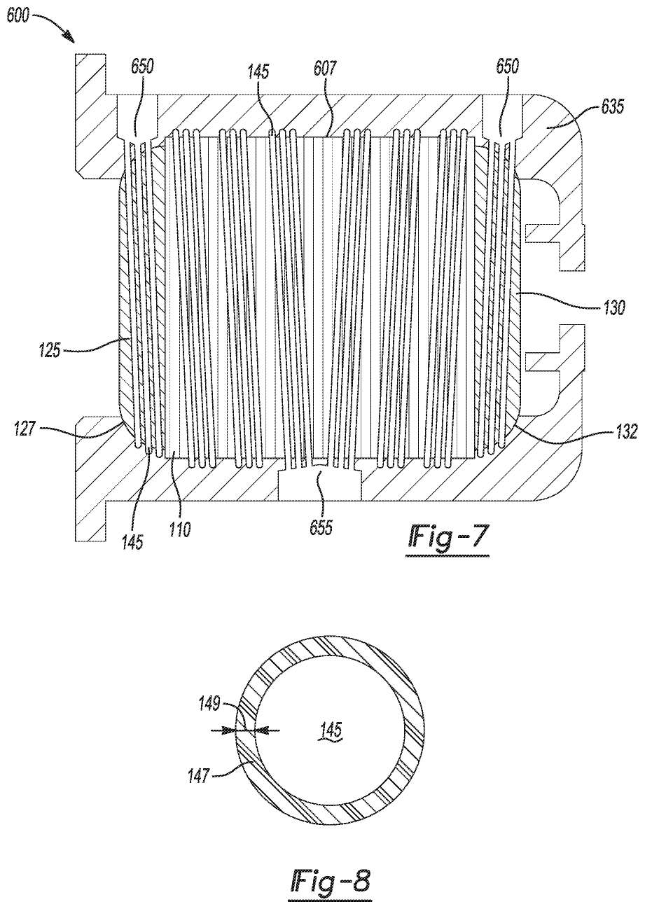

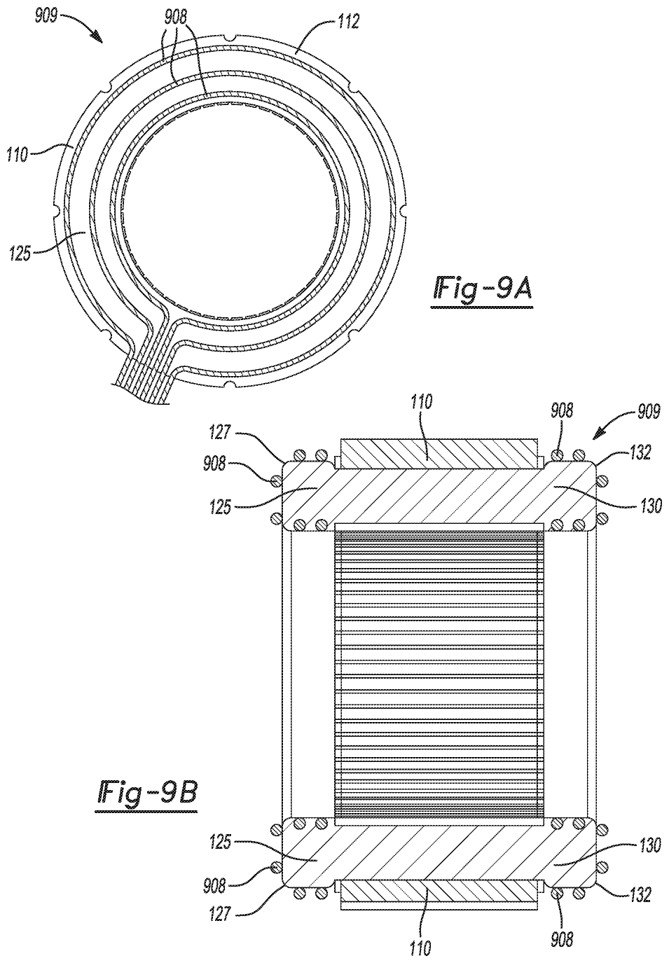

In alternative embodiments, a polymeric composite housing with channels defined therein may also be disposed adjacent to an exterior surface of a plurality of laminations in a stator assembly for further cooling and/or heating of a stator assembly. For example, as depicted in FIGS. 6 and 7, a stator 600, also referred to a stator assembly 600, may include a plurality of laminations 110 as described herein, a plurality of wire windings as described herein, a first plurality of winding end-turns 125 as described herein and a second plurality of winding end-turns 130 as described herein. The stator 600 further includes a polymeric composite housing 635 which may be disposed around at least portion of one or more of: (i) an exterior surface 607 of the laminations 110; (ii) a first outer periphery 127 of the first plurality of winding end-turns 125; and (iii) a second outer periphery 132 of the second plurality of winding end-turns 130. In some embodiments, as depicted in FIGS. 6 and 7, the polymer composite housing 635 is disposed around the exterior surface 607 of the laminations 110, the first outer periphery 127 of the first plurality of winding end-turns 125, and the second outer periphery 132 of the second plurality of winding end-turns 130.

A plurality of channels 145 as described herein are defined in the polymeric composite housing 635. The channels 145 may be oriented in any suitable configuration in the polymeric composite housing 635, for example, circumferentially, radially, branched, intersecting, criss-crossing and combinations thereof. In some embodiments, the channels 145 may extend circumferentially around one or more of: (i) the exterior surface 607 of the laminations 110; (ii) the first plurality of winding end-turns 125; and (iii) the second plurality of winding end-turns 130. As depicted in FIGS. 6 and 7, the channels 145 may extend circumferentially around: (i) the exterior surface 607 of the laminations 110; (ii) the first plurality of winding end-turns 125; and (iii) the second plurality of winding end-turns 130. Although not shown, it is contemplated herein that the channels 145 may extend circumferentially around only the exterior surface 607 of the laminations 110 and not circumferentially around the first plurality of winding end-turns 125; and (iii) the second plurality of winding end-turns 130.

In some embodiments, at least a portion of the channels 145 in the polymeric composite housing 635 may be interconnected with one another including fluidly interconnected and/or physically interconnected. As depicted in FIGS. 6 and 7, channels 145 in the polymeric composite housing 635 may comprise third inlets 650 for receiving a heat transfer fluid and a third outlet 655 for removal of the spent heat transfer fluid. The third inlets 650 may comprise one or more channels 145, and the third outlet 655 may comprise one or more channels 145. While two third inlets 650 and one third outlet 655 are shown in FIGS. 6 and 7, it is contemplated herein that the stator 600 may include only one third inlet 650 or more than two third inlets 650 and/or more than one third outlet 655. It is also contemplated herein, that a third inlet 650 and a third outlet 655 may be present in various locations in the polymeric composite housing 635, for example, a third inlet 650 and a third outlet 655 may present in the polymeric composite housing 635 near the laminations 110 for only cooling and/or heating the laminations 110.

In various aspects, the heat transfer fluid may be supplied by at least one pump (not shown) from at least one supply reservoir or supply channel (not shown) to at least one inlet (e.g., first inlet 150, second inlet 160, third inlet 650) in the polymeric composite housing (e.g., first polymeric composite housing 135, second polymeric housing 140, polymeric composite housing 635) in the stator assembly (e.g., stator assembly 100, stator assembly 400, stator assembly 500, stator assembly 600). The pump and supply reservoir may be present adjacent to the stator assembly. Optionally, the heat transfer fluid may flow through a cooler (not shown) to further reduce the temperature of the heat transfer fluid or the heat transfer fluid may flow through a heater (not shown) to increase the temperature of the heat transfer fluid.

In any embodiment, the channels 145 each may have any suitable cross-section, for example, a substantially round cross-section, substantially rectangular cross-section or a combination thereof. As understood herein, “substantially round” may include circular and oval cross-sections and the dimensions of the cross-section may deviate in some aspects. As understood herein, “substantially rectangular” may include square cross-sections and the dimensions of the cross-section may deviate in some aspects. Each of the channels 145 may have a diameter of about 10 μm to about 25 mm, about 50 μm to about 15 mm, about 100 μm to about 10 mm, about 500 μm to about 10 mm, about 1 mm to about 10 mm, or about 1 mm to about 5 mm.

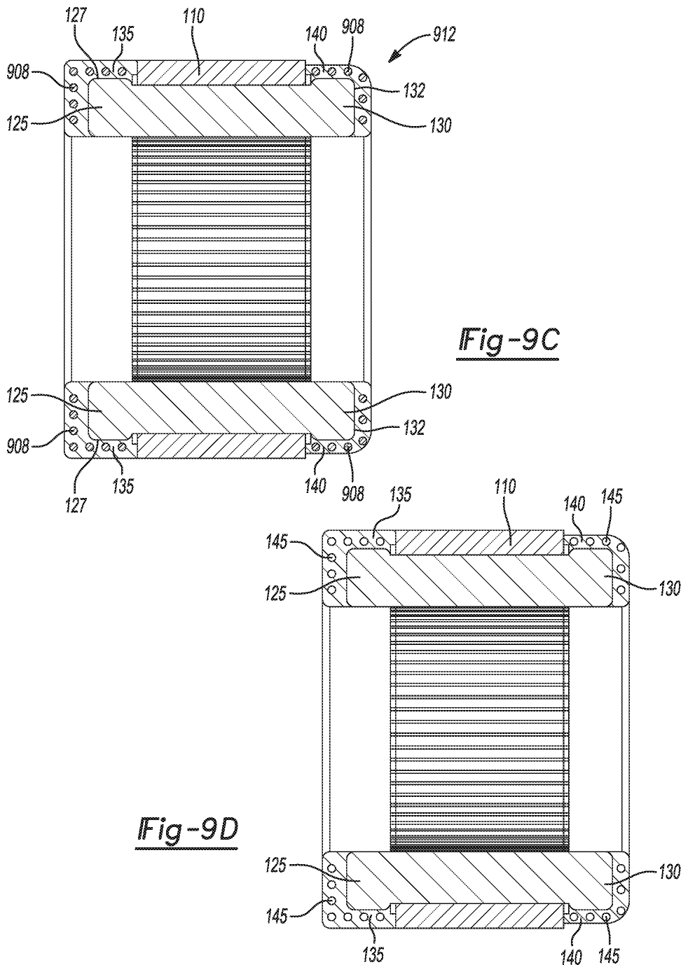

In some embodiments, as depicted in FIG. 8, which shows a cross-section of a single channel 145, a channel 145 may comprise an outer shell 147 having a wall thickness 149. The wall thickness 149 may range from about 1 μm to about 5 mm, about 50 μm to about 2.5 mm, about 100 μm to about 1 mm, or about 200 μm to about 800 μm. In various aspects, the outer shell 147 may comprise a metal (e.g., stainless steel, copper, aluminum), a polymer (epoxy, nylon, polyphthalamide (PPA), polyphenylene sulfide (PPS), nylon, polypropylene (PP), polyethylene (PE)), a polymeric composite, a ceramic, or a combination thereof.

As further described below, the channels 145 can be formed by applying a channel precursor material comprising a sacrificial material to the stator to form an intermediate stator assembly, placing the intermediate stator assembly in a mold, introducing a polymer precursor into the mold, solidifying the polymer precursor to form a polymeric composite housing (e.g., first polymeric composite housing 135, second polymeric housing 140, polymeric composite housing 635), and removing the sacrificial material to form the plurality of channels 145.

In any embodiment, the polymeric composite housing (e.g., first polymeric composite housing 135, second polymeric housing 140, polymeric composite housing 635) may comprise any suitable polymer and optionally, a plurality of suitable reinforcing fibers and/or straps. Examples of suitable polymers include, but are not limited to a thermoset polymer (e.g., thermoset resin), a thermoplastic polymer (e.g., thermoplastic resin), elastomer and combination thereof. Preferable polymers include, but are not limited to epoxies, phenolics, vinylesters, bismaleimides, polyether ether ketone (PEEK), polyamides, polyimides and polyamideimides. Examples of suitable reinforcing fibers and/or straps include, but are not limited to carbon fibers, carbon fiber straps, glass fibers, aramid fibers, polyethylene fibers, organic fibers, metallic fibers, ceramic fibers, basalt fibers, quartz fibers, graphite fibers, nanofibers, boron fibers, and combinations thereof. In particular, the reinforcing fibers and/or straps are glass fibers, carbon fibers, and/or carbon fiber straps. The reinforcing fibers may be continuous fibers or discontinuous fibers. In particular, the reinforcing fibers are continuous fibers. Advantageously, the polymeric composite housing (e.g., first polymeric composite housing 135, second polymeric housing 140, polymeric composite housing 635) comprising a polymeric composite material as described herein may have a compression strength of about 100 MPa to about 2000 MPa, about 500 MPa to about 1000 MPa or about 1000 MPa to about 1500 MPa.

### II. Methods of Making the Stator Assemblies

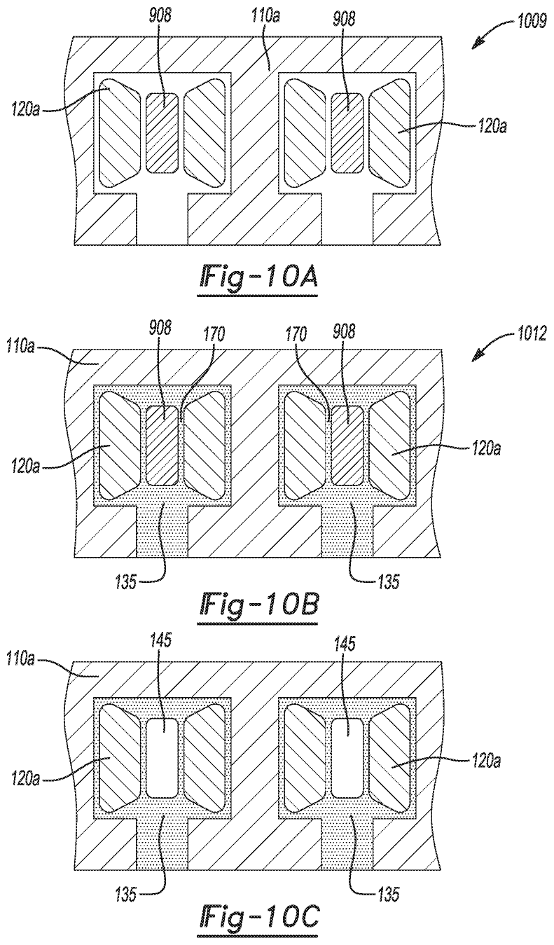

Methods of making the stator assemblies described herein are also provided. The method may include an application step comprising applying a channel precursor material comprising a sacrificial material to a stator to form an intermediate stator assembly. The stator may include a plurality of laminations as described herein (e.g., laminations 110) each comprising a plurality of slots as described herein (e.g., slots 115). The stator further includes a plurality of wire windings as described herein (e.g., wire windings 120) disposed in the slots, a first plurality of winding end-turns as described herein (e.g., winding-end turns 125), and a second plurality of winding end-turns as described herein (e.g., winding-end turns 130). An exemplary depiction of the application step is shown in FIGS. 9A and 9B. FIG. 9A shows a flattened top view of a stator body including a first plurality of wire windings 125 adjacent to a first end face 112 of a plurality of slots (not shown) of a plurality of laminations 110. In FIG. 9A, the application step comprises applying channel precursor material 908 circumferentially around the first plurality of winding end-turns 125 to form intermediate stator assembly 909. Additionally or alternatively, the application step comprises applying channel precursor material 908 circumferentially around the second plurality of winding end-turns 130, as depicted in FIG. 9B, which shows a flattened cross-section of intermediate stator assembly 909. In any embodiment, the channel precursor material 908 can be held in place adjacent to the first plurality of winding end-turns 125 and/or the second plurality of winding end-turns 130 with any suitable adhesive or lacing. Although not shown, it is contemplated herein that the channel precursor material 908 can be applied to or within at least a portion of the wire windings 120.

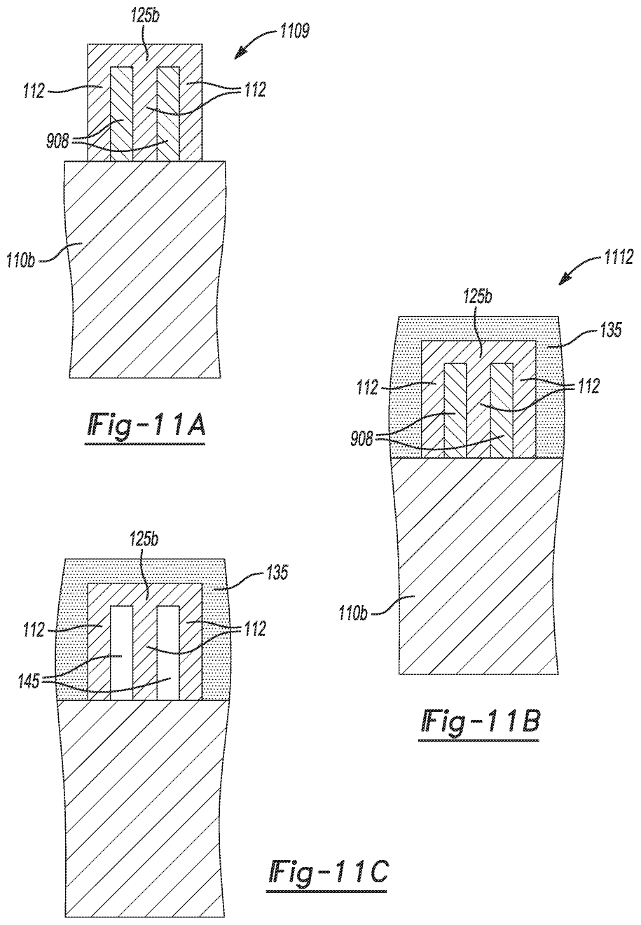

In an alternative embodiment, the application step may comprise applying the channel precursor material 908 radially between the wire windings 120a, and the winding end-turns in the first plurality of winding end-turns 125a to form intermediate stator assembly 1009, as depicted in FIG. 10A. FIG. 10A illustrates a flattened cross-sectional slice of the stator assembly 400 on a plane perpendicular to the rotational axis of the assembly in FIG. 4A including wire winding 120a, laminations 110a and channel precursor material 908 radially present in at least a portion of the gaps 170 between respective wire windings 120a. Although not shown, the application step includes applying channel precursor material 908 radially between winding end-turns 125a. Although not shown, the application step, additionally or alternatively, may further include applying the channel precursor material 908 radially between respective wire windings and respective winding end-turns in a second plurality of winding end-turns.

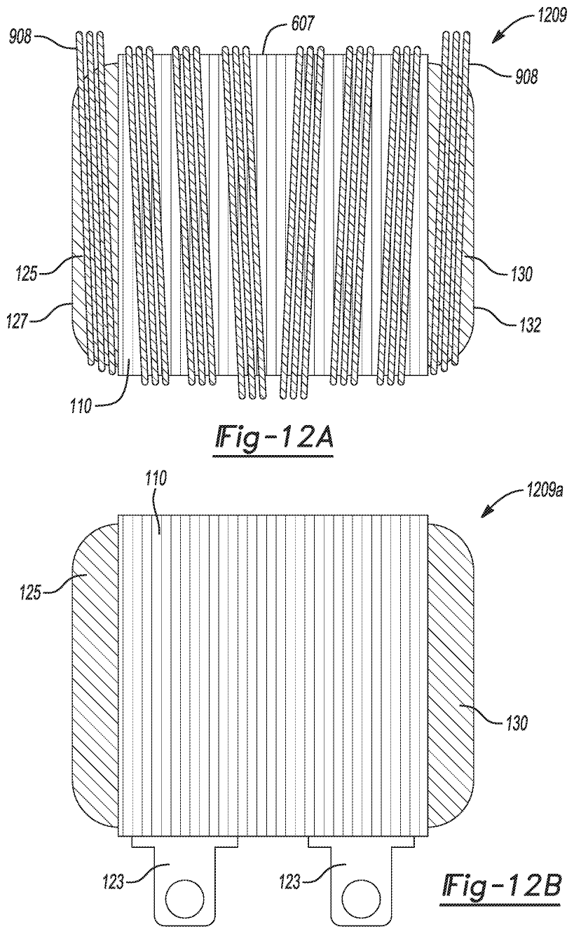

In another alternative embodiment, the application step may comprise applying the channel precursor material 908 to at least a portion of regions between the respective wire windings 112 (or wires 112) of the first plurality of winding end-turns 125b to form intermediate stator assembly 1109, as illustrated in FIG. 11A. FIG. 11A depicts a cross-sectional slice of the stator assembly 500 along line C-C from FIG. 5A including winding end-turns 125b, laminations 110b, and channel precursor material 908 present in the regions 180 (not shown because channel precursor material 908 is present) between the wire windings 112 of the first plurality of winding end-turns 125b. Although not shown, the application step, additionally or alternatively, may further include applying the channel precursor material to at least a portion of regions between the respective wire windings of the second plurality of winding end-turns.

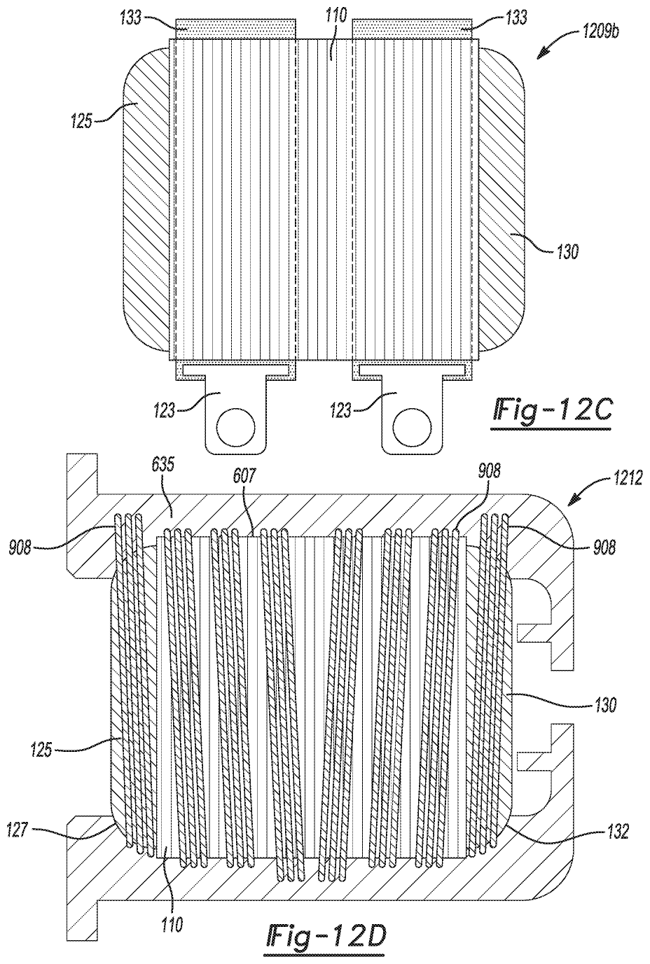

In another alternative embodiment, the application step may comprise applying the channel precursor material 908 circumferentially around one or more of: (i) an exterior surface 607 of a plurality of laminations 110, (ii) the first plurality of winding end-turns 125, and (iii) the second plurality of winding-end turns 130 to form intermediate stator assembly 1209, as shown in FIG. 12A. Optionally, as shown in FIGS. 12B and 12C, an insert 123 may be applied to the intermediate stator assembly 1209 for additional structural rigidity to form intermediate stator assembly 1209a. The insert 123 may comprise metallic or continuous fibers. Optionally, as depicted in FIG. 12C, the insert 123 may be attached to a carbon fiber strap 133 to form intermediate stator assembly 1209b. For clarity purposes in FIGS. 12B and 12, the channel precursor material 908 is not shown. Alternatively, the insert 123, optionally attached to a carbon fiber strap 133 may be applied laminations 110 before application of the channel precursor material 908.

In any embodiment, the method further includes a potting step comprising placing the intermediate stator assembly (e.g., intermediate stator assembly 909, intermediate stator assembly 1009, intermediate stator assembly 1109, intermediate stator assembly 1209) in a mold (not shown), introducing a polymer precursor into the mold, and solidifying (e.g., cooling, reacting, cross-linking) the polymer precursor under suitable conditions to form a solid polymeric stator assembly comprising a polymer. The polymer precursor may include any suitable polymer precursor or polymer for forming the polymer, for example, for forming a thermoset polymer (e.g., thermoset resin), a thermoplastic polymer (e.g., thermoplastic resin), elastomer and a combination thereof. Preferable polymers include, but are not limited to epoxies, phenolics, vinylesters, bismaleimides, polyether ether ketone (PEEK), polyamides, polyimides and polyamideimides. In some embodiments, the polymeric composite housing (e.g., first polymeric composite housing 135, second polymeric composite housing 140, polymeric composite housing 635) may be formed by injection molding. For example, the mold may include a housing defined void space for receiving a a polymer precursor. The housing defined void space may be defined by a metal or polymer boundary present in the mold, which delineates the shape of the polymeric composite housing. The polymer precursor may be introduced into the mold followed by solidification (e.g., cooling, reacting, cross-linking) to form solid polymeric stator assembly comprising the polymeric composite housing (e.g., first polymeric composite housing 135, second polymeric composite housing 140, polymeric composite housing 635). Alternatively, the polymeric composite housing (e.g., first polymeric composite housing 135, second polymeric composite housing 140, polymeric composite housing 635) may be formed by other suitable techniques, such as, but not limited to, pultrusion, reaction injection molding, compression molding, prepreg molding (in autoclave or as compression molding), resin transfer molding, and vacuum assisted resin transfer molding.

For example, as depicted in FIG. 9C, a solid polymeric stator assembly 912 was formed during a potting step by placing intermediate stator assembly 909 in a mold (not shown), introducing a polymer precursor (not shown) into the mold, and solidifying the polymer precursor to form solid polymeric stator assembly 912. Solid polymeric stator assembly 912 may include a first polymeric composite housing 135 disposed around at least a portion of the first outer periphery 127 of the first plurality of winding end-turns 125 and a second polymeric composite housing 140 disposed around at least a portion of the second outer periphery 132 of the second plurality of winding end-turns 130. The channel precursor material 908 is disposed in the first polymeric composite housing 135 and the second polymeric composite housing 140. The first polymeric composite housing 135 and the second polymeric composite housing 140 each comprises a polymer as described herein. Although not shown, it contemplated herein that polymer precursor may be introduced to other portions of a stator assembly, for example, the polymer precursor may contact at least a portion of the wire windings 120, for example, portions of the wire windings 120 that have channel precursor material applied thereto or within.

In an alternative embodiment, as depicted in FIG. 10B, a cured stator assembly 1012 was formed during a potting step by placing intermediate stator assembly 1009 in a mold (not shown), introducing a polymer precursor (not shown) into the mold, and solidifying the polymer precursor to form solid polymeric stator assembly 1012. Solid polymeric stator assembly 1012 may include laminations 110a, a first plurality of winding end-turns 125a, a first polymeric composite housing 135 comprising a polymer as described herein, and the channel precursor material 908 disposed within the first polymeric composite housing 135. Although not shown, the solid polymeric stator assembly 1012 may further include a second plurality of winding end-turns, a second polymeric composite housing comprising a polymer as described herein, and the channel precursor material disposed within the second polymeric composite housing.

In another alternative embodiment, as depicted in FIG. 11B, a solid polymeric stator assembly 1112 was formed during a potting step by placing intermediate stator assembly 1109 in a mold (not shown), introducing a polymer precursor (not shown) into the mold, and solidifying the polymer precursor to form solid polymeric stator assembly 1112. Solid polymeric stator assembly 1112 may include laminations 110b, a first polymeric composite housing 135 comprising a polymer as described herein, and channel precursor material 908 disposed in the regions between the wires 112 of the first plurality of winding end-turns 125b. Although not shown, the solid polymeric stator assembly 1112 may further include a second polymeric composite housing comprising a polymer as described herein, and channel precursor material disposed in the regions between the wires of the second plurality of winding end-turns.

In another alternative embodiment, as depicted in FIG. 12D, a solid polymeric stator assembly 1212 was formed during a potting step by placing intermediate stator assembly 1209 in a mold (not shown), introducing a polymer precursor (not shown) into the mold, and solidifying the polymer precursor to form solid polymeric stator assembly 1212. Solid polymeric stator assembly 1212 may include laminations 110, a polymeric composite housing 635 comprising a polymer as described herein disposed, and channel precursor material 908 disposed in the polymeric composite housing 635. The polymeric composite housing 635 can be disposed around: (i) at least a portion of the exterior surface 607 of the laminations 110; (ii) at least a portion of the outer periphery 127 of the first plurality of winding end-turns 125; and (iii) at least a portion of the outer periphery 132 of the second plurality of winding end-turns 130. Optionally, as shown in FIG. 12E, an insert 123, optionally attached to a carbon fiber strap 133, may be applied to the intermediate stator assembly 1209 for additional structural rigidity to form solid polymeric stator assembly 1212a.

In some embodiments, the method may further include, for example, during the application step or the potting step, optionally arranging a plurality of reinforcing fibers and/or straps adjacent to the intermediate stator assembly (e.g., intermediate stator assembly 909, intermediate stator assembly 1009, intermediate stator assembly 1109, intermediate stator assembly 1209). Examples of reinforcing fibers and/or straps include, but are not limited to, carbon fiber straps and continuous fibers selected from the group consisting of carbon fibers, glass fibers, aramid fibers, polyethylene fibers, organic fibers, metallic fibers, ceramic fibers, basalt fibers, quartz fibers, graphite fibers, nanofibers, boron fibers, and a combination thereof. The reinforcing fibers may be made by any other suitable methods known in the art, e.g., braiding, weaving, stitching, knitting, prepregging, hand-layup and robotic or hand placement of tows.

In some embodiments, polymeric composites can be formed by using strips of a composite precursor material, such as the reinforcing fibers. The composite may be formed with one or more layers, where each layer can be formed from contacting and/or overlapping strips of the fiber-based material. The reinforcing fibers may also comprise a polymer precursor (e.g., a polymer). The polymer precursor can be solidified (e.g., cooled, reacted, cross-linked) and thus can serve to bond single or multiple layers together in the polymeric composite. Various methods typically can be employed for introducing polymer precursor to impregnate fiber-based substrate composite material (e.g., reinforcing fibers) systems: wet winding (or layup), pre-impregnating (referred to as “pre-preg”), and resin transfer molding. For wet winding, a dry fiber reinforcement material (e.g., reinforcing fibers) can be wetted with the polymer precursor (e.g., resin) as it is used, usually by submersion through a bath. For pre-impregnating (pre-preg), the polymer precursor is wetted into the fiber-based material in advance, and usually includes a step of partially solidifying the polymer precursor to have a viscous or tacky consistency (also known as a B-stage partial cure), and then winding up the pre-preg fiber-based material for later use. Pre-preg composite material systems tend to use thermoset resin systems, which can be solidified by elevated temperatures with solidification times ranging from about 1 minute to about 2 hours (depending solidification temperatures). However, some pre-preg materials may employ resins that solidify with actinic radiation (e.g., ultraviolet radiation (UV)). For resin transfer molding, dry fiber reinforcement material may be placed into a mold and resin may be infused into the mold under pressure (e.g., about 10 psi to about 2000 psi). Injection molding techniques known in the art may also be used to introduce polymer precursor (e.g., resin) into the reinforcement material, particularly where the reinforcement material comprise discontinuous fibers. For example, a precursor comprising a polymer precursor (e.g., resin) and the reinforcement material may be injected or infused into a defined space or mold followed by solidification of the precursor to form the polymeric composite material. The term “injection molding” also includes reaction injection molding using a thermoset polymer.

In certain other aspects, the present teachings also contemplate an attaching step where a fiber-based reinforcement material (e.g., reinforcing fibers) is applied, for example, via filament winding, braiding or weaving near, within, and/or over a work surface (e.g., intermediate stator assembly 909, intermediate stator assembly 1009, intermediate stator assembly 1109, intermediate stator assembly 1209). The method may optionally comprise applying or introducing a polymer precursor (e.g., unreacted resin) composition into or onto the fiber-based reinforcement material. By applying, it is meant that the unreacted polymer precursor composition is wetted out onto the fiber-based reinforcement material and thus may be coated on a surface of the fiber-based reinforcement material or imbibed/impregnated into the fiber-based reinforcement material (for example, into the pores or openings within the reinforcing fibers). After the polymer precursor is introduced to the regions having the reinforcement material, followed by solidifying (e.g., curing or reacting) to form the polymeric composite. Pre-preg fiber-based material may be applied via filament winding, braiding or weaving as well

After the potting step, the solid polymeric stator assembly (e.g., solid polymeric stator assembly 912, solid polymeric stator assembly 1012, solid polymeric stator assembly 1112, solid polymeric stator assembly 1212) may be further treated (e.g., heated) in a removal step to remove sacrificial material of the channel precursor material 908 to form a plurality of channels 145 defined in one or more of: (i) the first polymeric composite housing 135; (ii) the second polymeric composite housing 145; (iii) the polymeric composite housing 635 (iv) regions between the wires of the first plurality of winding end-turns; and (v) regions between the wires of the second plurality of winding end-turns. For example, FIGS. 9D, 10C, 11C, 12F illustrate the channels 145 formed after the removal step.

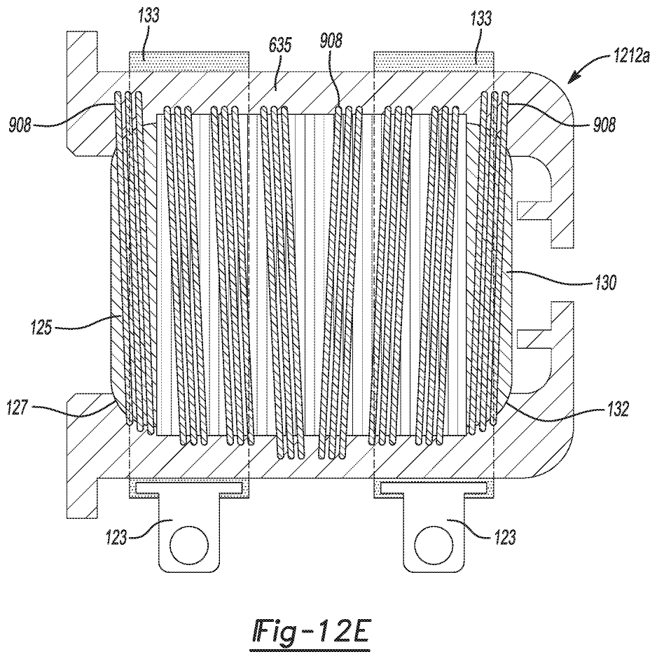

As shown in FIG. 13A, a channel precursor material 908, such as a fiber, comprise a sacrificial material 920. In some embodiments, as shown in FIG. 13B, the channel precursor 908a may further comprise an outer shell 147 as described herein (e.g., metal, polymer, polymeric composite, ceramic or combination thereof) containing or encapsulating the sacrificial material 920. In any embodiment, the sacrificial material 920 may be comprise a material capable of one or more of: melting, vaporizing, deflagrating, and solubilizing. Examples of suitable sacrificial material 920 includes, but is not limited to metals, polymers, deflagrating materials, and combinations thereof. Non-limiting metals may include solders, which comprise lead, tin, zinc, aluminum, suitable alloys and the like. Non-limiting polymers may include polyvinyl acetate, polylactic acid, polyethylene, polystyrene. Non-limiting deflagrating materials may include ceramics, salts (e.g., potassium nitrate), black powder, charcoal, pentaerythritol tetranitrate, combustible metals, combustible oxides, thermites, nitrocellulose, pyrocellulose, flash powders, smokeless powder, and combinations thereof. Additionally or alternatively, the sacrificial material 920 may further be treated with a catalyst or chemically modified to alter melting or degradation behavior. In some embodiments, where the channel precursor 908a includes an outer shell 147, the sacrificial material 920 may also be a gas, such as air.

Thus, the removal step may comprise volatilizing, melting, deflagrating or degrading the sacrificial material 920 or the sacrificial material 920 may be dissolved to produce degradants. For example, the sacrificial material 920 may be heated to a temperature (e.g., about 150° C. to about 200° C.) or subject to a reaction that substantially vaporizes, melts, or deflagrates the sacrificial material 920 but does not substantially degrade the polymeric composite housing and optionally, the reinforcing fibers. Any suitable solvent, such as, but not limited to acetone, may be applied to the materials to dissolve them, optionally with agitation, so long as the solvent does not substantially degrade or dissolve the polymeric composite housing and optionally, the reinforcing fibers. Alternatively, the sacrificial materials may be etched using a suitable acid (e.g., hydrochloric acid, sulfuric acid, nitric acid, and the like). Although not shown, it is contemplated herein, that the methods described herein also include providing access to the channel precursor material 908, for example, by drilling into the polymeric composite housing, 8 so that the removal step may be performed on the sacrificial material. The degradants may be removed to form channels 145 in the polymeric composite housing (e.g., first polymeric composite housing 135, second polymeric composite housing 140, polymeric composite housing 635), for example, by applying a vacuum to the polymeric composite housing or introducing a gas to the polymeric composite housing to expel the degradants out of the polymeric composite housing. In some embodiments, where the channel precursor material 908 includes an outer shell 147, the outer shell 147 remains after the degradants have been removed.

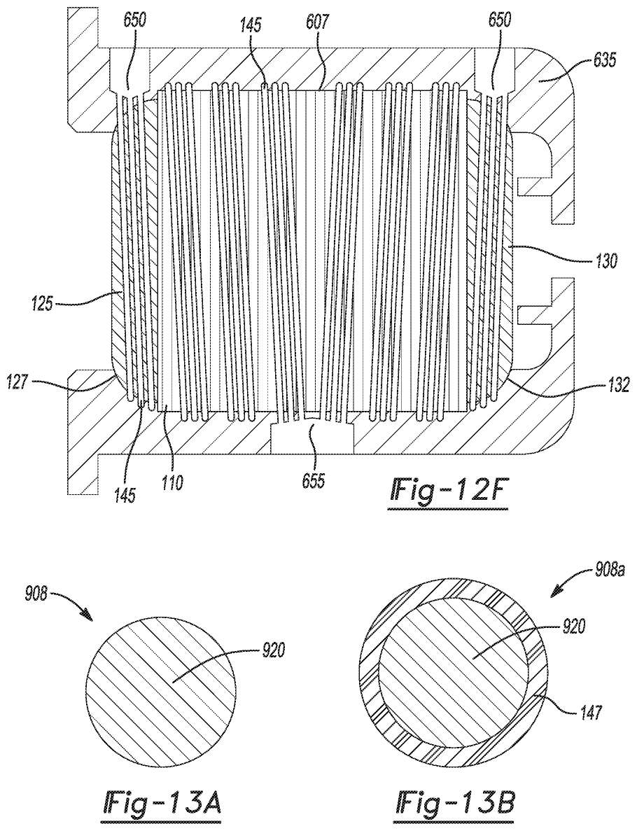

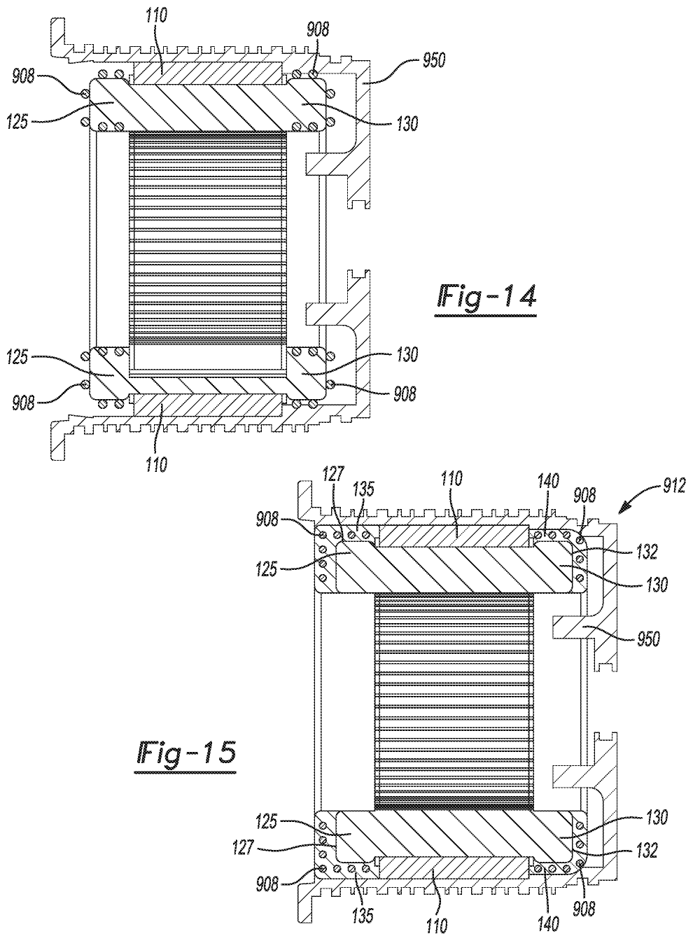

In some optional embodiments, the intermediate stator assembly 909 may be placed in a stator housing 950, as shown in FIG. 14, followed by placing the intermediate stator assembly 909 in the stator housing 950 in a mold (not shown) to perform the potting step. Additionally or alternatively, the solid polymeric stator assembly 912 optionally may be placed in a stator housing 950 before removing the sacrificial material 920, as shown in FIG. 15.

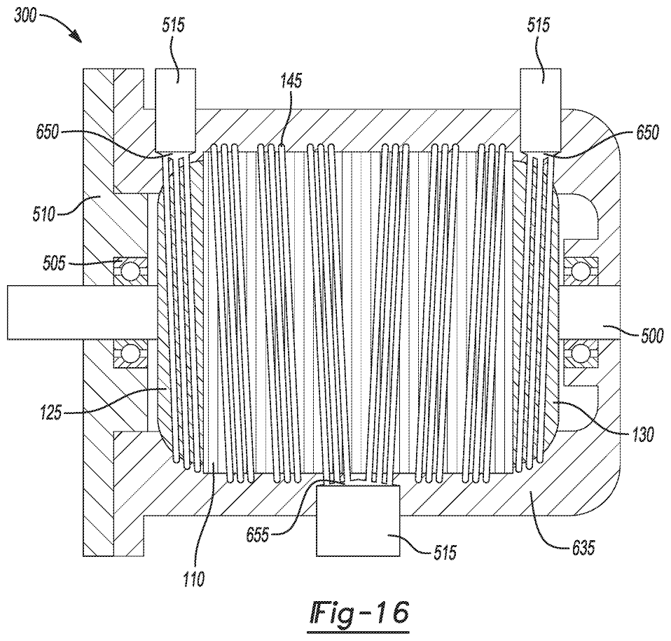

Additionally or alternatively, the method may comprise further steps for assembling an electric motor. For example, following removal of the sacrificial material 920, an electric motor 300 can be assembled by providing and assembling a shaft 500, a bearing 505, a housing bell 510, and tube fittings 515 for accessing third inlets 650 and third outlet 655, as depicted in FIG. 16.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A stator for an electric motor comprising:
a plurality of laminations each comprising a plurality of slots, wherein the plurality of slots collectively define a first end face and a second end face;
a plurality of wire windings disposed in the plurality of slots;
a first plurality of winding end-turns formed by the respective wire windings adjacent to the first end face;
a second plurality of winding end-turns formed by the respective wire windings adjacent to the second end face, wherein the first plurality of winding end-turns has a first outer periphery and the second plurality of winding end-turns has a second outer periphery;
a first polymeric composite housing disposed around at least a portion of the first outer periphery of the first plurality of winding end-turns;
a second polymeric composite housing disposed around at least a portion of the second outer periphery of the second plurality of winding end-turns, wherein the first polymeric composite housing and the second polymeric composite housing each comprises a polymer; and
a plurality of channels for receiving a fluid for heating and/or cooling the first plurality of winding end-turns and/or the second plurality of winding end-turns,
wherein the plurality of channels are defined in one or more of:
(i) the first polymeric composite housing;
(ii) the second polymeric composite housing;
(iii) regions between respective wire windings of the first plurality of winding end-turns; and
(iv) regions between respective wire windings of the second plurality of winding end-turns.

2. The stator of claim 1, wherein the polymer in the first and the second polymeric composite housing each comprises a thermoplastic polymer or thermoset polymer.

3. The stator of claim 1, wherein the first and the second polymeric composite housing each further comprises a plurality of reinforcing fibers, wherein the plurality of reinforcing fibers are continuous fibers selected from the group consisting of carbon fibers, glass fibers, aramid fibers, polyethylene fibers, organic fibers, metallic fibers, ceramic fibers, basalt fibers, quartz fibers, graphite fibers, nanofibers, boron fibers, and a combination thereof.

4. The stator of claim 1, wherein the plurality of channels comprise an outer shell comprising a metal, a polymer, a polymeric composite, a ceramic, or a combination thereof.

5. The stator of claim 1, wherein the plurality of channels are defined in the first polymeric composite housing and in the second polymeric composite housing, and wherein the plurality of channels in the first polymeric composite housing extend circumferentially around the first plurality of winding end-turns, and the plurality of channels in the second polymeric composite housing extend circumferentially around the second plurality of winding end-turns.

6. The stator of claim 5, wherein the plurality of channels in the first polymeric composite housing are interconnected with one another and the plurality of channels in the second polymeric composite housing are interconnected with one another.

7. The stator of claim 5, wherein the plurality of channels in the first polymeric composite housing respectively comprise a first inlet and a first outlet and the plurality of channels in the second polymeric composite housing respectively comprise a second inlet and a second outlet.

8. The stator of claim 5, wherein the plurality of channels in the first polymeric composite housing are in fluid communication with the plurality of channels in the second polymeric composite housing.

9. The stator of claim 1, wherein the plurality of channels are defined in the first polymeric composite housing and in the second polymeric composite housing, and wherein the plurality of channels in the first polymeric composite housing extend radially between respective winding end-turns in the first plurality of winding end-turns and between the respective wire windings, and the plurality of channels in the second polymeric composite housing extend radially between respective winding end-turns in the second plurality of winding end-turns and between the respective wire windings.

10. The stator of claim 9, wherein the plurality of channels in the first polymeric composite housing are interconnected with one another by a first manifold channel, and the plurality of channels in the second polymeric composite housing are interconnected with one another by a second manifold channel.

11. The stator of claim 1, wherein the plurality of channels are formed by:
applying a channel precursor material comprising a sacrificial material to the stator to form an intermediate stator assembly;
placing the intermediate stator assembly in a mold;
introducing a polymer precursor into the mold;
solidifying the polymer precursor to form the first polymeric composite housing and the second polymer composite housing; and
removing the sacrificial material to form the plurality of channels.

12. A method of manufacturing a stator with a plurality of channels comprising:
applying a channel precursor material comprising a sacrificial material to the stator to form an intermediate stator assembly,
wherein the stator comprises:
a plurality of laminations each comprising a plurality of slots,
wherein the plurality of slots collectively define a first end face and a second end face;
a plurality of wire windings disposed in the plurality of slots;
a first plurality of winding end-turns formed by the respective wire windings adjacent to the first end face; and
a second plurality of winding end-turns formed by the respective wire windings adjacent to the second end face, wherein the first plurality of winding end-turns has a first outer periphery and the second plurality of winding end-turns has a second outer periphery;
placing the intermediate stator assembly in a mold;
introducing a polymer precursor into the mold;
solidifying the polymer precursor to form a solid polymeric stator assembly comprising a first polymeric composite housing disposed around at least a portion of the first outer periphery of the first plurality of winding end-turns and a second polymeric composite housing disposed around at least a portion of the second outer periphery of the second plurality of winding end-turns, wherein the first polymeric composite housing and the second polymeric composite housing each comprises a polymer; and
removing the sacrificial material to form the plurality of channels defined in one or more of:
(i) the first polymeric composite housing;
(ii) the second polymeric composite housing;
(iii) regions between the respective wire windings of the first plurality of winding end-turns; and
(iv) regions between the respective wire windings of the second plurality of winding end-turns.

13. The method of claim 12, wherein the polymer comprises a thermoplastic polymer or a thermoset polymer.

14. The method of claim 12, wherein applying the channel precursor material comprises applying the channel precursor material circumferentially around the first plurality of winding end-turns, and applying the channel precursor material circumferentially around the second plurality of winding end-turns.

15. The method of claim 12, wherein applying the channel precursor material comprises applying the channel precursor material to at least a portion of the regions between the respective wire windings of the first plurality of winding end-turns and the second plurality of winding end-turns.

16. The method of claim 12, wherein applying the channel precursor material comprises applying the channel precursor material radially between respective winding end-turns in the first plurality of winding end-turns, and applying the channel precursor material radially between respective winding end-turns in the second plurality of winding end-turns.

17. The method of claim 12, wherein the sacrificial material comprises a material capable of one or more of melting, vaporizing, deflagrating, and solubilizing.

18. The method of claim 12, wherein the channel precursor material further comprises an outer shell containing the sacrificial material, wherein the outer shell comprises a metal, a polymer, a polymeric composite, a ceramic, or a combination thereof, wherein the sacrificial material comprises a gas or a material capable of one or more of melting, vaporizing, deflagrating, and solubilizing, and wherein the shell remains after the sacrificial material is removed.

19. The method of claim 12, further comprising removing the solid polymeric stator assembly from the mold and placing the solid polymeric stator assembly in a stator housing before removing the sacrificial material or further comprising placing the intermediate assembly in the stator housing and placing the intermediate assembly in the stator housing in the mold.

20. A stator for an electric motor comprising:
a plurality of laminations each comprising a plurality of slots, wherein the plurality of slots collectively define a first end face and a second end face, and wherein the plurality of laminations has as an exterior surface;
a plurality of wire windings disposed in the plurality of slots;
a first plurality of winding end-turns formed by the respective wire windings adjacent to the first end face;
a second plurality of winding end-turns formed by the respective wire windings adjacent to the second end face, wherein the first plurality of winding end-turns has a first outer periphery and the second plurality of winding end-turns has a second outer periphery;
a polymeric composite housing disposed around: (i) at least a portion of the exterior surface of the laminations; (ii) at least a portion of the first outer periphery of the first plurality of winding end-turns; and (iii) at least a portion of the second outer periphery of the second plurality of winding end-turns; wherein the polymeric composite housing comprises a polymer; and
a plurality of channels for receiving a fluid for heating and/or cooling the stator, wherein the plurality of channels are defined in the polymeric composite housing.

21. The stator of claim 20, wherein the polymer in the polymeric composite housing comprises a thermoplastic polymer or a thermoset polymer.

22. The stator of claim 20, wherein the polymeric composite housing further comprises a plurality of reinforcing fibers, wherein the plurality of reinforcing fibers are continuous fibers selected from the group consisting of carbon fibers, glass fibers, aramid fibers, polyethylene fibers, organic fibers, metallic fibers, ceramic fibers, basalt fibers, quartz fibers, graphite fibers, nanofibers, boron fibers, and a combination thereof.

23. The stator of claim 20, wherein the plurality of channels comprise an outer shell comprising a metal, a polymer, a polymeric composite, a ceramic, or a combination thereof.

24. The stator of claim 20, wherein the plurality of channels in the polymeric composite housing extend circumferentially around: (i) the exterior surface of the laminations; (ii) the first plurality of winding end-turns; and (iii) the second plurality of winding end-turns.

25. The stator of claim 20, wherein the plurality of channels are interconnected with one another.

26. The stator of claim 20, wherein the plurality of channels comprise a third inlet and a third outlet.

27. The stator of claim 20, wherein the plurality of channels are formed by:
applying a channel precursor material comprising a sacrificial material to the stator to form an intermediate stator assembly;
placing the intermediate stator assembly in a mold;
introducing a polymer precursor into the mold;
solidifying the polymer precursor to form the polymeric composite housing; and
removing the sacrificial material to form the plurality of channels.

28. A method of manufacturing a stator with a plurality of channels comprising:
applying a channel precursor material comprising a sacrificial material to the stator to form an intermediate stator assembly,
wherein the stator comprises:
a plurality of laminations each comprising a plurality of slots,
wherein the plurality of slots collectively defining a first end face and a second end face, and wherein the plurality of laminations has as an exterior surface;
a plurality of wire windings disposed in the plurality of slots;
a first plurality of winding end-turns formed by the respective wire windings adjacent to the first end face; and
a second plurality of winding end-turns formed by the respective wire windings adjacent to the second end face, wherein the first plurality of winding end-turns has a first outer periphery and the second plurality of winding end-turns has a second outer periphery;
placing the intermediate stator assembly in a mold;
introducing a polymer precursor into the mold;
solidifying the polymer precursor to form a solid polymeric stator assembly comprising a polymeric composite housing disposed around: (i) at least a portion of the exterior surface of the laminations; (ii) at least a portion of the first outer periphery of the first plurality of winding end-turns; and (iii) at least a portion of the second outer periphery of the second plurality of winding end-turns; wherein the polymeric composite housing comprises a polymer; and
removing the sacrificial material to form the plurality of channels defined in the polymeric composite housing.

29. The method of claim 28, wherein the polymer comprises a thermoplastic polymer or a thermoset polymer.

30. The method of claim 28, wherein the channel precursor material further comprises a plurality of reinforcing fibers or the method further comprises arranging the plurality of reinforcing fibers adjacent to at least a portion of the intermediate stator assembly, wherein the plurality of reinforcing fibers are continuous fibers selected from the group consisting of carbon fibers, glass fibers, aramid fibers, polyethylene fibers, organic fibers, metallic fibers, ceramic fibers, basalt fibers, quartz fibers, graphite fibers, nanofibers, boron fibers, and a combination thereof.

31. The method of claim 28, wherein applying the channel precursor material comprises applying the channel precursor material circumferentially around: (i) the exterior surface of the laminations; (ii) the first plurality of winding end-turns; and (iii) the second plurality of winding end-turns.

32. The method of claim 28, wherein the sacrificial material comprises a material capable of one or more of melting, vaporizing, deflagrating, and solubilizing.

33. The method of claim 28, wherein the channel precursor material further comprises an outer shell containing the sacrificial material, wherein the outer shell comprises a metal, a polymer, a polymeric composite, a ceramic or a combination thereof, wherein the sacrificial material comprises gas or a material capable of one or more of melting, vaporizing, deflagrating, and solubilizing, and wherein the shell remains after the sacrificial material is removed.

34. The method of claim 28, further comprising applying an insert to the intermediate stator assembly.

35. A stator for an electric motor comprising:
a stator body comprising a plurality of laminations, a plurality of wire windings, and a plurality of winding end-turns formed by the respective wire windings;
a polymeric composite housing disposed around at least a portion of an exterior surface of the stator body, wherein the polymeric composite housing comprises a polymer; and
a plurality of channels for receiving a fluid for heating and/or cooling the stator, wherein the plurality of channels are defined in the polymeric composite housing.

36. The stator of claim 35, wherein the polymer in the polymeric composite housing comprises a thermoplastic polymer or a thermoset polymer.

37. The stator of claim 35, wherein the polymeric composite housing further comprises a plurality of reinforcing fibers, wherein the plurality of reinforcing fibers are continuous fibers selected from the group consisting of carbon fibers, glass fibers, aramid fibers, polyethylene fibers, organic fibers, metallic fibers, ceramic fibers, basalt fibers, quartz fibers, graphite fibers, nanofibers, boron fibers, and a combination thereof.

38. The stator of claim 35, wherein the channels comprise an outer shell comprising a metal, a polymer, a polymeric composite, a ceramic, or a combination thereof.

39. The stator of claim 35, wherein the plurality of channels are formed by:
applying a channel precursor material comprising a sacrificial material to the stator body to form an intermediate stator assembly;
placing the intermediate stator assembly in a mold;
introducing a polymer precursor into the mold;
solidifying the polymer precursor to form the polymeric composite housing; and
removing the sacrificial material to form the plurality of channels.
